(19) United States
(12) Patent Application Publication
(10) Pub. No.: US 2022/0392109 A1
(43) Pub. Date: Dec. 8, 2022

(54) METHODS AND APPARATUS FOR DYNAMIC DISTORTION CORRECTION

(71) Applicant: QUALCOMM Incorporated, San Diego, CA (US)

(72) Inventors: Bijan FORUTANPOUR, San Diego, CA (US); Yellamraju TARUN, San Diego, CA (US)

(21) Appl. No.: 17/341,291

(22) Filed: Jun. 7, 2021

(51) Int. Cl. G06T 7/80; G06T 5/00; G06T 5/50; G06T 7/40; G01M 11/02

(52) U.S. Cl. CPC G06T 7/80; G06T 5/006; G06T 5/50; G06T 7/40; G01M 11/0242; G02B 27/0093

(57) ABSTRACT

The present disclosure relates to methods and devices for data or graphics processing including an apparatus, e.g., a GPU. The apparatus may determine a plurality of viewing positions and a plurality of viewing directions for one or more lenses. The apparatus may also measure an amount of distortion of the one or more lenses for each of the plurality of viewing positions and each of the plurality of viewing directions. Also, the apparatus may adjust pre-distortion data for each of the plurality of viewing positions and each of the plurality of viewing directions. The apparatus may also determine a pre-distortion estimation for each of the plurality of viewing positions and each of the plurality of viewing directions. The apparatus may also generate lens calibration data for all of the plurality of viewing positions and all of the plurality of viewing directions based on the pre-distortion estimation.

### TECHNICAL FIELD

The present disclosure relates generally to processing systems and, more particularly, to one or more techniques for data or graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU) or any apparatus that can perform data or graphics processing. The apparatus may determine a plurality of viewing positions and a plurality of viewing directions for one or more lenses. The apparatus may also measure an amount of distortion of the one or more lenses for each of the plurality of viewing positions and each of the plurality of viewing directions. Additionally, the apparatus may update at least one of the plurality of viewing positions or at least one of the plurality of viewing directions for the one or more lenses. The apparatus may also adjust, based on the measured distortion of the one or more lenses, pre-distortion data for each of the plurality of viewing positions and each of the plurality of viewing directions. The apparatus may also re-measure, upon adjusting the pre-distortion data, the amount of distortion of the one or more lenses for each of the plurality of viewing positions and each of the plurality of viewing directions. Moreover, the apparatus may re-adjust, based on the re-measured distortion of the one or more lenses, the pre-distortion data for each of the plurality of viewing positions and each of the plurality of viewing directions. The apparatus may also determine, upon adjusting the pre-distortion data, a pre-distortion estimation for each of the plurality of viewing positions and each of the plurality of viewing directions. The apparatus may also generate lens calibration data for all of the plurality of viewing positions and all of the plurality of viewing directions based on the pre-distortion estimation for each of the plurality of viewing positions and each of the plurality of viewing directions. Also, the apparatus may transmit the lens calibration data for all of the plurality of viewing positions and all of the plurality of viewing directions.

In another aspect of the disclosure, a method, a computer-readable medium, and an apparatus are provided. The apparatus may be a graphics processing unit (GPU) or any apparatus that can perform data or graphics processing. The apparatus may receive lens calibration data for a plurality of viewing positions and a plurality of viewing directions. The apparatus may also generate, based on the lens calibration data, a pixel map including a plurality of calibration points associated with the plurality of viewing positions and the plurality of viewing directions, each of the plurality of calibration points being associated with a weighting factor. Further, the apparatus may determine a plurality of geometry meshes based on the lens calibration data, each of the plurality of geometry meshes including a set of texture coordinates. The apparatus may also determine a render mesh including a plurality of coordinates based on the plurality of geometry meshes and the pixel map, each of the plurality of coordinates in the render mesh being associated with the weighting factor for each of the plurality of calibration points. The apparatus may also render display content based on the determined render mesh including the plurality of coordinates. Additionally, the apparatus may transmit the display content after rendering the display content.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3A is a diagram illustrating an example eye compared to a display lens in accordance with one or more techniques of this disclosure.

FIG. 3B is a diagram illustrating an example eye compared to a display lens in accordance with one or more techniques of this disclosure.

FIG. 3C is a diagram illustrating an example eye compared to a display lens in accordance with one or more techniques of this disclosure.

FIG. 4 is a diagram illustrating an example data capture and calibration process in accordance with one or more techniques of this disclosure.

FIG. 5A is a diagram illustrating an example data grid for a data capture and calibration process in accordance with one or more techniques of this disclosure.

FIG. 5B is a diagram illustrating an example data grid for a data capture and calibration process in accordance with one or more techniques of this disclosure.

FIG. 6A is a diagram illustrating an example pixel map for a rendering application in accordance with one or more techniques of this disclosure.

FIG. 6B is a diagram illustrating an example pixel map for a rendering application in accordance with one or more techniques of this disclosure.

FIG. 7A is a diagram illustrating an example eye compared to a display lens in accordance with one or more techniques of this disclosure.

FIG. 7B is a diagram illustrating an example eye compared to a display lens in accordance with one or more techniques of this disclosure.

FIG. 8 is a diagram illustrating an example initialization/calibration process and runtime process in accordance with one or more techniques of this disclosure.

FIG. 9 is a communication flow diagram illustrating example communications between a GPU pipeline, a GPU component, and a memory/buffer in accordance with one or more techniques of this disclosure.

FIG. 10 is a flowchart of an example method of data or graphics processing in accordance with one or more techniques of this disclosure.

FIG. 11 is a flowchart of an example method of data or graphics processing in accordance with one or more techniques of this disclosure.

FIG. 12 is a flowchart of an example method of data or graphics processing in accordance with one or more techniques of this disclosure.

FIG. 13 is a flowchart of an example method of data or graphics processing in accordance with one or more techniques of this disclosure.

### DETAILED DESCRIPTION

Aspects of extended reality (XR), augmented reality (AR), or virtual reality (VR) content may include lens distortion correction, which may attempt to ensure that straight lines are displayed as straight lines to the user, rather than as curved or distorted lines as a result of lens distortion. Lens distortion may also include a number of different problems or challenges. For instance, the accurate display of content via lens distortion may be a challenge considering the inconsistent eye location and/or gaze direction of users of XR/AR/VR content within headsets or head-mounted displays (HMDs). In some instances, XR/AR/VR device distortion correction may be calibrated for a central position of eye (i.e., coincident with an optical center of the lens) and for a straight viewing orientation. In practice, a user's eyes may not perfectly align with this position and viewing orientation, such as due to head rotation and/or user motion, a headset/HMD may move relative to a user's head, which also introduces misalignment in the eye position and/or gaze direction. If there is misalignment in eye position and/or gaze direction, the optics of the headset/HMD introduce distortions, which the user may perceive as scene shifting and/or virtual object deformations (e.g., straight lines will appear bent). Another problem is the real-time usage of the calibration data during runtime of the XR/AR/VR content. Aspects of the present disclosure may account for inconsistencies in eye position and/or gaze direction for users of XR/AR/VR content. Also, aspects of the present disclosure may measure for discrepancies in eye position and/or gaze direction lens distortion for XR/AR/VR devices. For example, aspects of the present disclosure may gradually adjust measurements of eye position and/or gaze direction during a lens calibration process for XR/AR/VR devices. Moreover, aspects of the present disclosure may optimize real-time playback using calibration data, e.g., interpolated calibration data, for XR/AR/VR devices.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

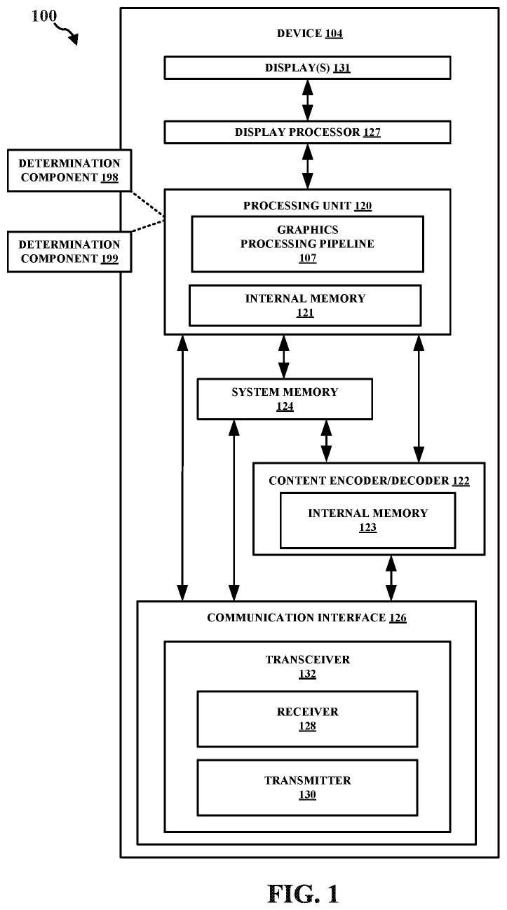

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a determination component 198 configured to determine a plurality of viewing positions and a plurality of viewing directions for one or more lenses. The determination component 198 may also be configured to measure an amount of distortion of the one or more lenses for each of the plurality of viewing positions and each of the plurality of viewing directions. The determination component 198 may also be configured to update at least one of the plurality of viewing positions or at least one of the plurality of viewing directions for the one or more lenses. The determination component 198 may also be configured to adjust, based on the measured distortion of the one or more lenses, pre-distortion data for each of the plurality of viewing positions and each of the plurality of viewing directions. The determination component 198 may also be configured to re-measure, upon adjusting the pre-distortion data, the amount of distortion of the one or more lenses for each of the plurality of viewing positions and each of the plurality of viewing directions. The determination component 198 may also be configured to re-adjust, based on the re-measured distortion of the one or more lenses, the pre-distortion data for each of the plurality of viewing positions and each of the plurality of viewing directions. The determination component 198 may also be configured to determine, upon adjusting the pre-distortion data, a pre-distortion estimation for each of the plurality of viewing positions and each of the plurality of viewing directions. The determination component 198 may also be configured to generate lens calibration data for all of the plurality of viewing positions and all of the plurality of viewing directions based on the pre-distortion estimation for each of the plurality of viewing positions and each of the plurality of viewing directions. The determination component 198 may also be configured to transmit the lens calibration data for all of the plurality of viewing positions and all of the plurality of viewing directions.

Referring again to FIG. 1, in certain aspects, the processing unit 120 may include a determination component 199 configured to receive lens calibration data for a plurality of viewing positions and a plurality of viewing directions. The determination component 199 may also be configured to generate, based on the lens calibration data, a pixel map including a plurality of calibration points associated with the plurality of viewing positions and the plurality of viewing directions, each of the plurality of calibration points being associated with a weighting factor. The determination component 199 may also be configured to determine a plurality of geometry meshes based on the lens calibration data, each of the plurality of geometry meshes including a set of texture coordinates. The determination component 199 may also be configured to determine a render mesh including a plurality of coordinates based on the plurality of geometry meshes and the pixel map, each of the plurality of coordinates in the render mesh being associated with the weighting factor for each of the plurality of calibration points. The determination component 199 may also be configured to render display content based on the determined render mesh including the plurality of coordinates. The determination component 199 may also be configured to transmit the display content after rendering the display content. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

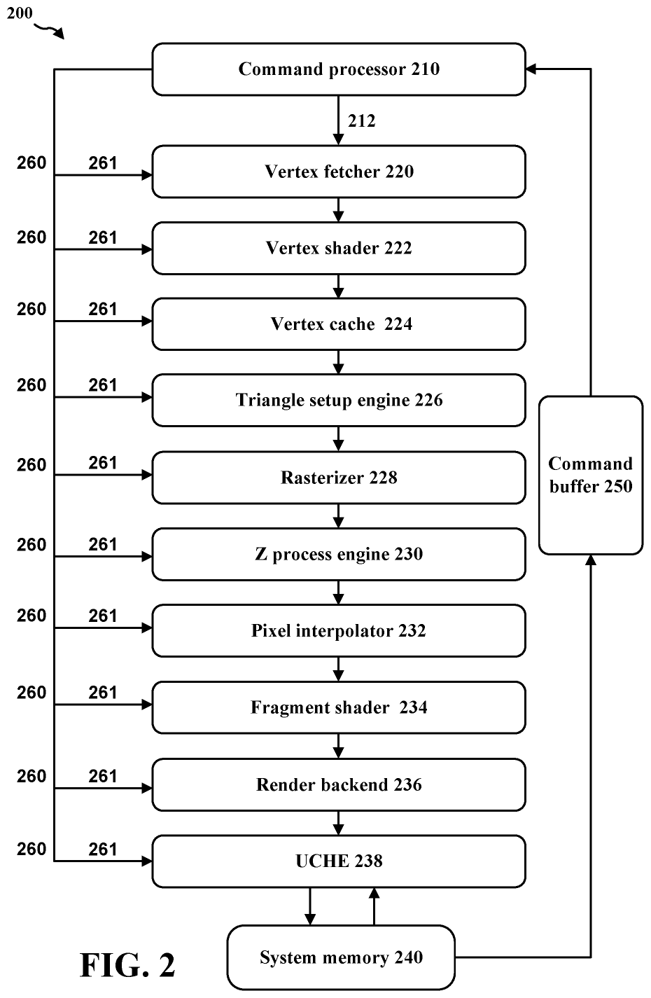

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

Aspects of the present disclosure can be applied to a number of different types of content, e.g., virtual reality (VR) content, augmented reality (AR) content, and/or extended reality (XR) content. In VR content, the content displayed at the user device can correspond to augmented content, e.g., content rendered at a server or user device. In AR or XR content, a portion of the content displayed at the user device can correspond to real-world content, e.g., objects in the real world, and a portion of the content can be augmented content. Also, the augmented content and real-world content can be displayed in an optical see-through or a video see-through device, such that the user can view real-world objects and augmented content simultaneously.

In some aspects, in VR camera see-through mode, a VR headset can be utilized as an AR headset. For example, two external cameras pointing outward can capture real-world objects, e.g., in left and right camera images. The left and right camera images can also be displayed in an internal LCD or OLED display. Additionally, a pair of display lenses can be mounted in front of the display. The user can then view the external world via the display lens, the display, and/or the external camera. In some aspects, the external camera can be referred to as a tracking camera, as it can track images in the real world. So the images shown on the display or client device can be the images that are tracked by the tracking camera. As such, the real world image can be tracked by the camera lens, and then transferred to the display and/or the display lens. Also, the lenses can bend light, which can result in distortion.

In some instances, because there are multiple lenses, each lens can distort the input image. Lens distortion correction can be applied to the multiple lenses, such that straight lines can remain straight as seen by the user. So lens distortion correction may attempt to ensure that straight lines are displayed as straight lines to the user, rather than as curved or distorted lines as a result of the lens distortion. Additionally, each lens can have different distortions. Further, the order of the lens distortion correction can matter, as the reversal of the lens distortion order may result in a different corrected image. Lens distortion can also include a number of different specifications. For example, lens distortion corrections may be mobile platform friendly, lens distortion corrections may be fast, e.g., 60 frames per second or more, and lens distortion corrections may leverage the GPU for performance aspects.

Aspects of lens distortion may also include a number of different problems or challenges. For instance, the accurate display of content via lens distortion may be a challenge considering the inconsistent eye location and/or gaze direction of users of XR/AR/VR content within headsets or HMDs. That is, as the eye position and/or gaze direction within headsets or HMDs may not be consistent, it is not easily predictable for lens distortion correction purposes. Indeed, the accurate display of content in XR/AR/VR devices for users with different eye positions or gaze directions, such that it is displayed correctly to a user at any eye position and/or gaze direction, is a non-trivial problem in lens distortion correction. This prediction of eye position and/or gaze direction may also be considered along with many optical, physical, and/or mobile platform performance complexities.

The issue of eye position and/or gaze direction may arise from the difference in the calibration of XR/AR/VR display lenses compared to the use of the lens in practice relative to the eyes of a user. For instance, some lens calibration systems may calibrate the lens as follows: (1) a camera is placed such that it is aligned at the center of the lens, (2) a checkered pattern is displayed on a screen, (3) an image is captured by the camera, and (4) calibration information is calculated. In practice, the iris of a user's eye may not be center-aligned with the lens. Rather, the iris of a user's eye may be offset in alignment or offset due to eye rotation.

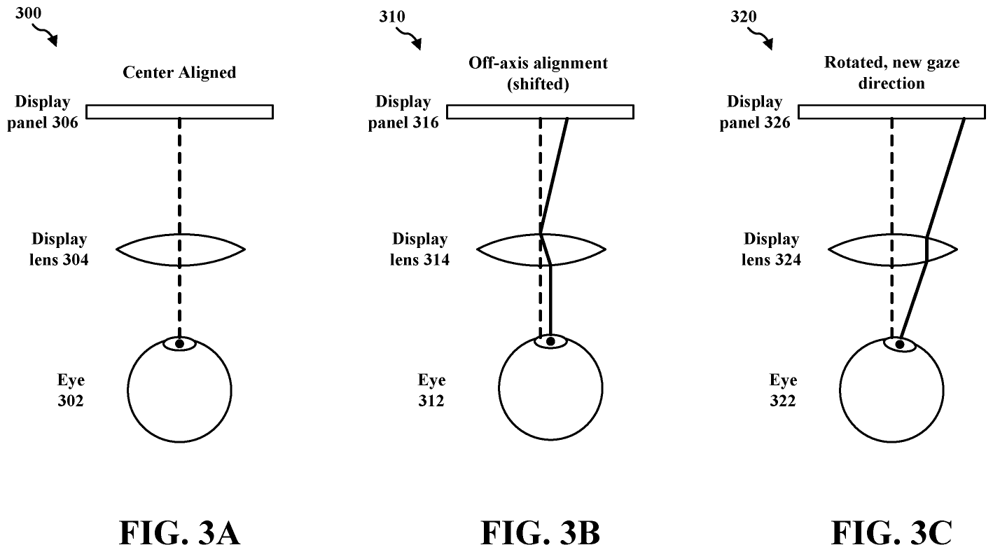

FIGS. 3A, 3B, and 3C illustrate diagrams 300, 310, and 320, respectively, of a user's eye compared to a display lens. More specifically, FIGS. 3A, 3B, and 3C display the aforementioned discrepancies between the calibration of XR/AR/VR display lenses compared to the use of a lens in practice, e.g., display lens 304, 314, and 324, relative to the eye of a user, e.g., eye 302, 312, and 322. FIGS. 3A, 3B, and 3C also depict the user's eye compared to a display panel, e.g., display panel 306, 316, and 326. As shown in FIG. 3A, diagram 300 depicts an ideal location of a user's eye, such that it is center-aligned with the display lens. However, in practice, as shown in FIGS. 3B and 3C, the iris of a user's eye may not be center-aligned with the lens. Diagram 310 in FIG. 3B shows that the iris of a user's eye may be offset or shifted, such that it is off-axis with the alignment of the display lens. Additionally, diagram 320 in FIG. 3C illustrates that the iris of the user's eye may be offset due to eye rotation, such as due to a new gaze direction. As shown in FIGS. 3B and 3C, the distance between the dotted lines and the pupil of the user's eye may be unaccounted for in practice.

In some instances, XR/AR/VR device distortion correction may be calibrated for a central position of eye (i.e., coincident with an optical center of the lens) and for a straight viewing orientation. In practice, a user's eyes may not perfectly align with this position and viewing orientation. Due to head rotation and/or user motion, a headset/HMD may move relative to a user's head, which also introduces misalignment in the eye position and/or gaze direction. If there is misalignment in eye position and/or gaze direction, the optics of the headset/HMD introduce distortions, which the user may perceive as scene shifting and/or virtual object deformations (e.g., straight lines will appear bent). This results in a user perception of the virtual world being incorrect and, in some cases, moving on its own, which breaks the immersion XR/AR/VR headsets or HMDs are aiming to achieve.

As indicated above, misalignment in eye position and/or gaze direction is a common problem for XR/AR/VR headsets or HMDs. Making progress towards addressing these issues will improve the user experience, immersion, and fidelity of virtual worlds. Addressing these issues can also mitigate factors contributing to motion sickness in XR/AR/VR. Another problem is the real-time usage of the calibration data during runtime of the XR/AR/VR content. As the amount of calibration data increases due to individually sampled eye gaze locations, combined with the many possibilities of potential gaze location and orientation that is not captured, more efficient performance is needed on mobile devices.

Based on the above, it may be beneficial to account for inconsistencies in eye position and/or gaze direction for users of XR/AR/VR content. Additionally, it may be beneficial to measure for discrepancies in eye position and/or gaze direction lens distortion for XR/AR/VR devices. For instance, it may be beneficial to gradually adjust measurements of eye position and/or gaze direction during a lens calibration process for XR/AR/VR devices. Further, it may be beneficial to optimize real-time playback using calibration data for XR/AR/VR devices.

Aspects of the present disclosure may account for inconsistencies in eye position and/or gaze direction for users of XR/AR/VR content. Also, aspects of the present disclosure may measure for discrepancies in eye position and/or gaze direction lens distortion for XR/AR/VR devices. For example, aspects of the present disclosure may gradually adjust measurements of eye position and/or gaze direction during a lens calibration process for XR/AR/VR devices. Moreover, aspects of the present disclosure may optimize real-time playback using calibration data, e.g., interpolated calibration data, for XR/AR/VR devices.

Aspects of the present disclosure may include a novel approach to lens calibration for XR/AR/VR devices. For instance, aspects of the present disclosure may provide an iterative feedback loop for capturing distortion patterns from different eye positions and gaze directions with respect to XR/AR/VR devices. This information may be used to generate compensation patterns for discrepancies in eye position or gaze direction. At each iteration, distortion may be observed after light passes through a display lens, which may introduce a spatially varying non-linear transformation. Any correction to mitigate distortion may be performed prior to light passing through the lens. This type of correction is non-linear, as the observation period is in post-lens non-linear domain, but the correction is in a pre-lens linear domain.

Aspects of the present disclosure may capture the distortion correction information at each iteration and combine it non-linearly by compositing mesh transformations. This allows aspects of the present disclosure to bypass non-linearity. For each capture position, aspects of the present disclosure may register an equivalent eye position and gaze, which builds up a database of distortion corrections for different positions. For example, aspects of the present disclosure may detect a user's eye position and gaze direction in real time with eye tracking cameras and generate an interpolated correction mesh using a previously generated database. Aspects of the present disclosure may include an iterative nature because it is difficult to gather necessary data at a required level of accuracy in one attempt, such as due to several limiting circumstances, e.g., blurring effect of lens, accuracy of corner detectors in challenging scenarios, visibility of all corners, etc.

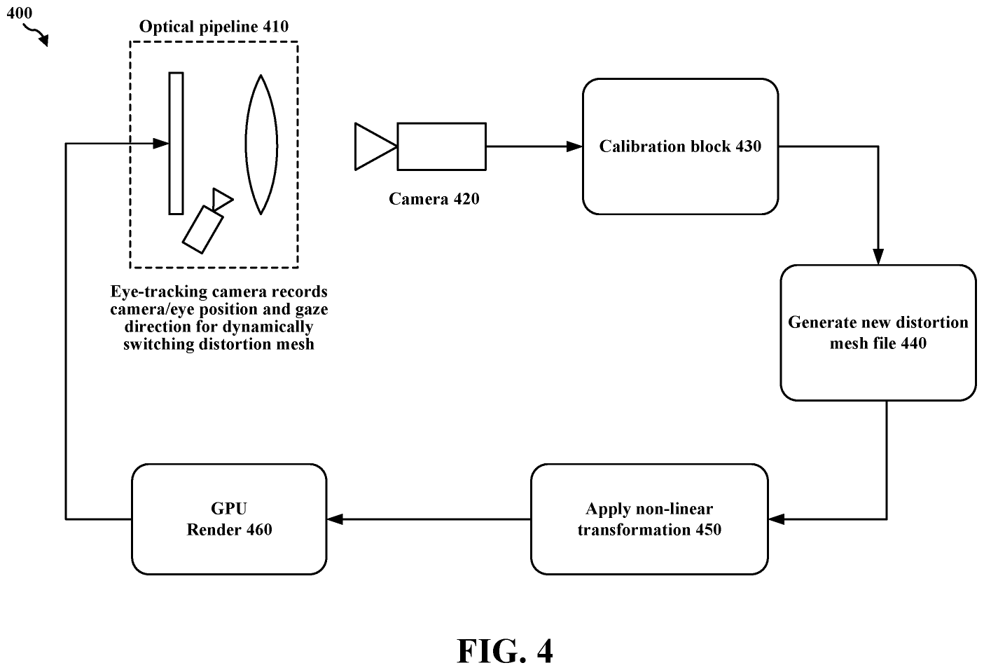

FIG. 4 illustrates a diagram 400 of a data capture and calibration process. At optical pipeline 410, aspects of the present disclosure may utilize an eye-tracking camera, e.g., camera 420, to record a camera/eye position and gaze direction for a dynamically switching distortion mesh. Aspects of the present disclosure may initialize with a ray tracing simulation centered distortion grid and/or utilize a pre-defined reference grid pattern. The camera 420 may be placed between display lenses or in a position comparable to a user's eye position. The camera 420 may be mounted on a robot arm or a six degrees of freedom (6dof) movable platform. The camera 420 may include a generic position, such that alignment may not be enforced. At calibration block 430, aspects of the present disclosure may detect distorted grid point locations relative to a display panel with reasonable accuracy. Calibration block 430 may also generate a quantitative measurement of observed distortion.

At step 440, aspects of the present disclosure may generate a new distortion mesh file. In order to do so, aspects of the present disclosure may reference locations indicating undistorted grid positions (e.g., positions that may need to be adjusted for camera position and orientation). Aspects of the present disclosure may also record distorted locations based on a camera position point of view. Further, aspects of the present disclosure may generate a new distortion mesh file for a particular state/iteration. This process may be repeated for each color channel to compensate for chromatic distortion. These steps may also be performed as a UV method during post-lens processing.

At step 450, aspects of the present disclosure may apply a non-linear transformation. For example, aspects of the present disclosure may daisy chain successive distortion grids to iteratively improve distortion compensation using a non-linear transform technique. Aspects of the present disclosure may also perform this process over multiple steps, such as to avoid attempting to get every step in the process correct in a single attempt. Aspects of the present disclosure may then pass on iteratively better distortion meshes to a GPU. This loop or process may be repeated until distortion compensation is optimal. Aspects of the present disclosure may also repeat this loop for different eye positions and/or orientations. At step 460, a GPU or software developer kit (SDK) may render content based on the distortion mesh.

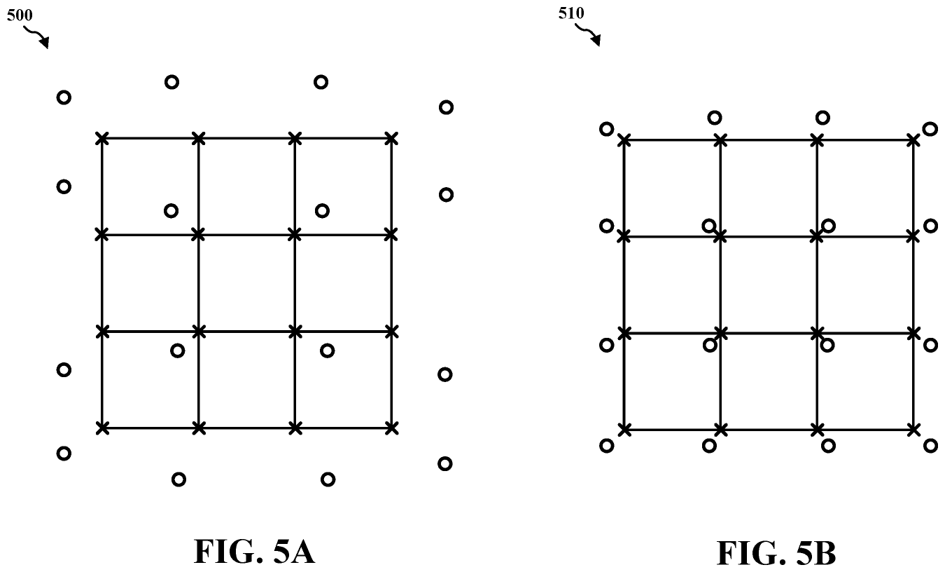

FIGS. 5A and 5B illustrate diagrams 500 and 510, respectively, of data grids for a data capture and calibration process. As shown in FIG. 5A, diagram 500 depicts one iteration, e.g., iteration n, in the data capture and calibration process. In FIG. 5A, the x′ points on the grid are the ideal view for a final solution, while the circles outside the grid are the distorted grid that is observed with a camera. The ‘x’s may correspond to the xyz coordinates on a display, which is known through construction. The circles may correspond to the uv coordinates detected through a camera, which is projected to a display space. As shown in FIG. 5A, if the circles in the distorted grid are too far from the ‘x’s in the ideal view, then the iteration will continue to run.

As shown in FIG. 5B, diagram 510 depicts another iteration, e.g., iteration n+1, in the data capture and calibration process. As shown in diagram 510, the circles in the distorted grid are close to the ‘x’s in the ideal view, so the iteration may stop running. That is, the iterative loop of the data capture and calibration process may stop when the circles (i.e., the distorted grid is observed with camera) coincide with the ‘x’s (i.e., the ideal final solution), e.g., the circles are less than a threshold away from the ‘x’s. Accordingly, aspects of the present disclosure may continue to run iterations of the data capture and calibration process until a distortion observed by a camera is close to an ideal final solution for the lens distortion.

The proposed framework in aspects of the present disclosure may enable the capture and correction of distortion patterns from a wide range of positions and orientations for a user's eyes. Relative to other approaches, this framework of the present disclosure may not impose restrictions or assumptions on the process beyond what may normally be visible to the human eye from a given location. With the inclusion of the non-linear transformation application, aspects of the present disclosure may successively incorporate non-linear delta corrections to generate a composite correction mesh. In contrast, other techniques may be limited to some extent of guessing corrections in the linear domain and may not be able to process corrections non-linearly. Also, other techniques may be able to determine direction of correction in the linear domain, but not magnitude if they impose assumptions and restrictions.

Aspects of the present disclosure may allow the determination of a direction and magnitude without the need for the guessing framework or any limiting assumptions and restrictions, i.e., to the extent allowed by corner detector accuracy. The framework may potentially converge in fewer iterations compared to other methods since aspects of the present disclosure can estimate directions and magnitudes of corrections without having to iteratively guess the correct quantity. XR, VR, and AR use cases for the framework of the present disclosure may improve visual fidelity and maximize user immersion.

Aspects of the present disclosure may include an application for runtime, e.g., a fast rendering of multiple calibration sets on a GPU. For instance, aspects of the present disclosure may generate a map where each pixel map location includes an identifier (ID) and a weighting factor. The ID may be an ID number of the closest calibration points or calibration origin points (COPs), e.g., the three closest calibration points, where a calibration camera gaze center is set. The weighting factor may be the weighting factor for each calibration point's contribution to that pixel (i.e., gaze) location. This map may be referred to as a pixel map or a COP map. The pixel map or COP map may be generated at an application initialization time. The weighting factors may be a tri-linear interpolations of three triangle points. This may be created by rendering, e.g., OpenGL rendering, which reads back pixel data.

Additionally, each calibration point or COP may correspond to a mesh to be rendered that performs the lens distortion correction for that particular gaze point. The mesh may be referred to as a geometry mesh or a COP geometry mesh. Different geometry meshes may be based on the lens calibration data, where each of the geometry meshes may include a set of texture coordinates. The different COP geometries may have different UV coordinate sets and identical XYZ coordinates. Thus, the UV coordinates for the mesh may be blended during runtime.

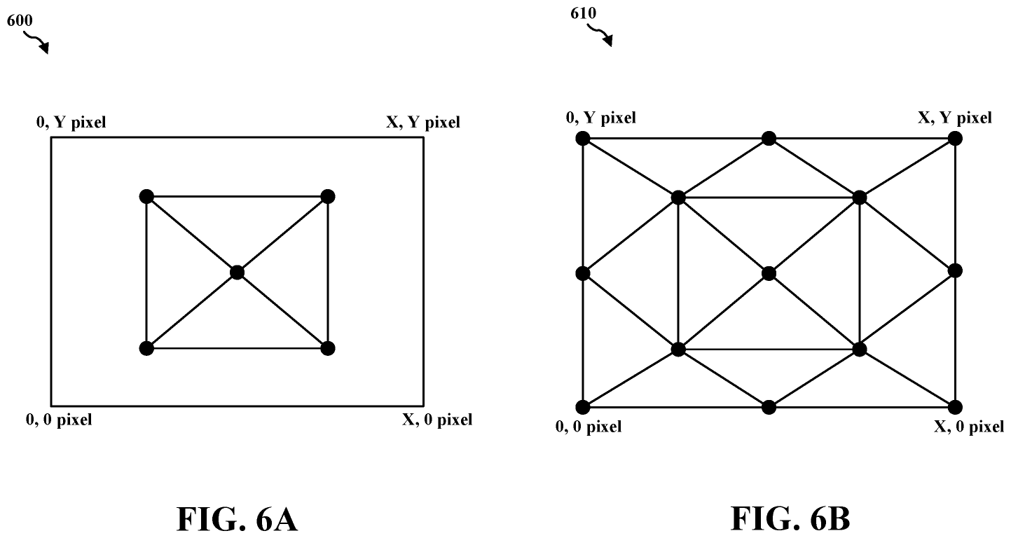

FIGS. 6A and 6B illustrate diagrams 600 and 610, respectively, of pixel maps for runtime of a rendering application of the aforementioned process. As shown in FIG. 6A, diagram 600 depicts a pixel map for a runtime of the rendering application. FIG. 6A includes a number of calibration points in the pixel map, where each pixel includes an XY coordinate. Diagram 610 in FIG. 6B displays another application of the pixel map including an increased number of calibration points, where each pixel includes an XY coordinate. In FIG. 6B, the calibration points represent the pixel location where the “look at” point (i.e., the point where a user eye is looking) of the calibration camera were set. Due to physical limitations of the HMD and/or camera controlling system (e.g., robot arm), calibration points may not exist at far corners and edges of the image. Additionally, aspects of the present disclosure may create virtual COP points and COP zones by interpolation.

In some aspects, during runtime, aspects of the present disclosure may perform a number of different operations per frame. For instance, aspects of the present disclosure may obtain the gaze location from an eye gaze detection system, e.g., an XY pixel location. Aspects of the present disclosure may also retrieve relevant COP ID points, e.g., three COP ID points, and their respective weights. Further, pass weights per COP and corresponding UV texture coordinates may be obtained, as attributes to a vertex shader in a GPU. In a vertex shader, the weights may be blended for per-vertex UV coordinates. In aspects of the present disclosure, the vertex shader may include a variety of code or pseudocode. For example, a vertex shader may include the following code:

#version 320 es
In vec4 position;
Uniform mat4 modelViewMatrix;
In vec2 UV0, UV1, UV2;
In vec4 weights;
Out vec2 vTexCoord;
Void main( )
{

g1_Position=position*modelViewMatrix;

vTexCoord=(UV0*weight[0])+(UV1*weight[1])+(UV2*weight[2]);

}

In some aspects, there may be multiple eye configurations that can point to the same pixel on the display. As the light ray paths may be different through the lens, the distorted images may be different as well. In order to account for this potential issue, aspects of the present disclosure may determine the interpupillary distance (i.e., position) compared to the eye rotation. To do so, aspects of the present disclosure may not include any additions to the pixel map described above. Further, aspects of the present disclosure may add a pupil rotation to the calibration point definition. Also, multiple calibration points that have the same XY position but different pupil rotation values may have the same ID number. The calibration point ID may act as a hash value in a hash table, and may provide a list of possible geometry meshes, e.g., COP geometry meshes. During runtime, when acquiring the geometry mesh, aspects of the present disclosure may include a search table for entries with a closest eye rotation value to the current eye tracking rotation value.

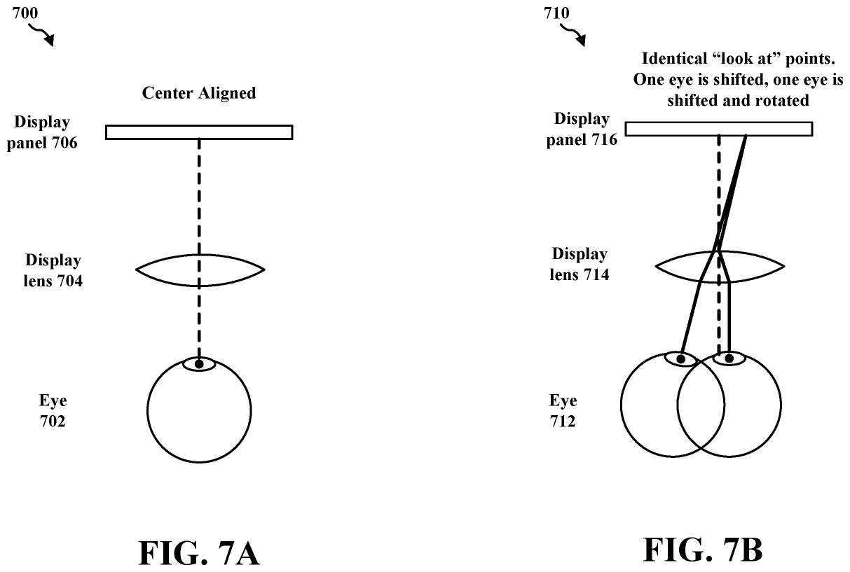

FIGS. 7A and 7B illustrate diagrams 700 and 710, respectively, of a user's eye, e.g., eye 702 and 712, compared to a display lens, e.g., display lens 704 and 714. FIGS. 7A and 7B also depict the user's eye compared to a display panel, e.g., display panel 706 and 716. As shown in FIG. 7A, diagram 700 depicts an ideal location of a user's eye, such that it is center-aligned with the display lens. Diagram 710 in FIG. 7B displays multiple eye locations with identical gaze or “look at” points, where one eye is shifted, an another eye is shifted and rotated. Accordingly, the “look at” point (i.e., the point where a user eye was looking) of multiple eyes may be the same even if the position and rotation of the eyes are different.

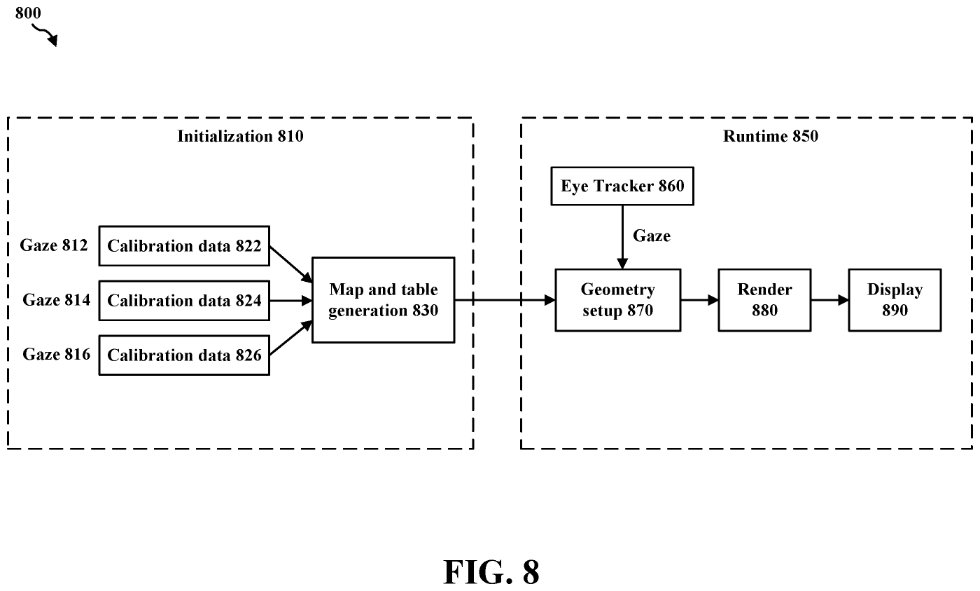

FIG. 8 illustrates diagram 800 of initialization/calibration portion 810 and runtime portion 850 of the aforementioned data capture and calibration process. As shown in FIG. 8, the initialization/calibration portion 810 includes three gazes, e.g., gaze 812, 814, and 816, and corresponding calibration data, e.g., calibration data 822, 824, and 826. The gaze may include the “look at” point coordinate and the eyeball rotation value. The calibration data may be combined at the map and table generation step 830. Once the pixel map and table are generated, they may be transmitted to the runtime portion 850. As shown in FIG. 8, the runtime portion 850 includes an eye tracker 860, which may determine a gaze. The gaze may be combined with the pixel map and table generation at the geometry setup 870. Once processed, this may be rendered at render step 880. After rendering, the rendered content may be displayed at display 890.

Aspects of the present disclosure may provide an improved speed for runtime processing. For instance, aspects of the present disclosure may perform calculations on a per-vertex basis rather than a per-pixel basis. Aspects of the present disclosure may also simplify the calculations to be a weighted sum of points of calibration data, e.g., three sample points of calibration data. Additionally, aspects of the present disclosure may avoid usage of texture maps for a lookup of calibration data. For example, texture map lookups may be costly compared to vertex attributes. Aspects of the present disclosure may take into account eyeball rotation for given gaze locations. Further, the aforementioned distortion correction approaches may be applied to a variety of optical systems used in different designs, e.g., AR, VR, and/or XR designs. Some of these systems may be complicated and may or may not involve lenses and may or may not involve other optical elements, e.g., waveguides, etc. Accordingly, aspects of the present disclosure may be applied to more generic situations than lens distortion. For instance, aspects of the present disclosure may extend beyond lenses to other types of optical systems, e.g., AR/VR/XR optical systems or the like.

Aspects of the present disclosure may include a number of benefits or advantages. For instance, aspects of the present disclosure may generate multi-iteration composite meshes with non-linear corrections, which can limit correction techniques to linear approaches. Aspects of the present disclosure may also include per-device calibration for distortion correction with measured data for distortion patterns at a single viewing position. Additionally, aspects of the present disclosure may improve visual fidelity of XR/AR/VR devices on a per-device basis, which may be dynamically based on user eye position and gaze. Aspects of the present disclosure may vastly improve the user experience, such as through enhancing immersion and/or reducing motion sickness. Moreover, aspects of the present disclosure may provide a per-device calibration tool. Aspects of the present disclosure may also include iterative correction estimates in the linear space. Aspects of the present disclosure may also include assumptions on camera positions to preserve directional estimates for correction vectors. Further, aspects of the present disclosure may determine the magnitude of a correction vector and iterate in a fixed step size search to obtain an optimal condition through empirical experimentation. Accordingly, aspects of the present disclosure may improve the overall user experience by reducing the amount of lens distortion.

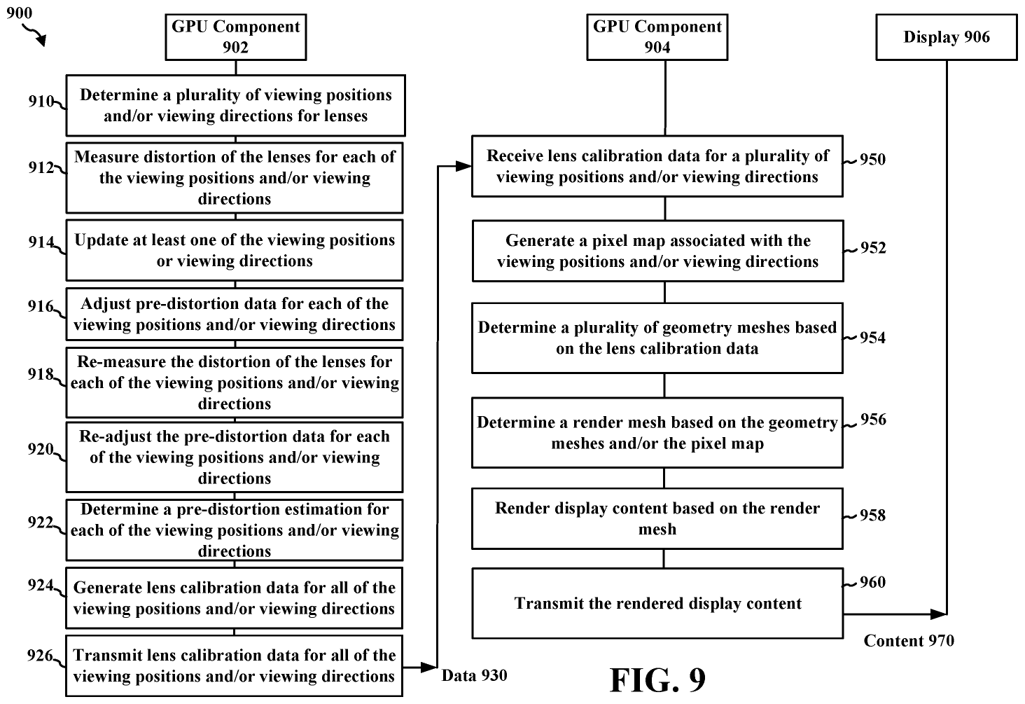

FIG. 9 is a communication flow diagram 900 of graphics processing in accordance with one or more techniques of this disclosure. As shown in FIG. 9, diagram 900 includes example communications between GPU component 902, GPU component 904, and display 906, e.g., a headset or HMD, in accordance with one or more techniques of this disclosure.

At 910, GPU component 902 may determine a plurality of viewing positions and a plurality of viewing directions for one or more lenses. The plurality of viewing positions may be determined based on a camera or an eye position of a user in a headset or a head-mounted display (HMD), where the plurality of viewing directions may be determined based on a camera or an eye gaze direction of a user in the headset or the HMD.

At 912, GPU component 902 may measure an amount of distortion of the one or more lenses for each of the plurality of viewing positions and each of the plurality of viewing directions. The amount of distortion of the one or more lenses may be based on light passing through the one or more lenses. Also, the amount of distortion of the one or more lenses may be associated with a spatially varying non-linear transformation.

At 914, GPU component 902 may update at least one of the plurality of viewing positions or at least one of the plurality of viewing directions for the one or more lenses.

At 916, GPU component 902 may adjust, based on the measured distortion of the one or more lenses, pre-distortion data for each of the plurality of viewing positions and each of the plurality of viewing directions.

At 918, GPU component 902 may re-measure, upon adjusting the pre-distortion data, the amount of distortion of the one or more lenses for each of the plurality of viewing positions and each of the plurality of viewing directions.

At 920, GPU component 902 may re-adjust, based on the re-measured distortion of the one or more lenses, the pre-distortion data for each of the plurality of viewing positions and each of the plurality of viewing directions. In some aspects, re-adjusting the pre-distortion data for each of the plurality of viewing positions and each of the plurality of viewing directions may further include combining a plurality of non-linear transformations or delta corrections for each of the plurality of viewing positions and each of the plurality of viewing directions.

At 922, GPU component 902 may determine, upon adjusting the pre-distortion data, a pre-distortion estimation for each of the plurality of viewing positions and each of the plurality of viewing directions. In some instances, if the pre-distortion estimation is greater than a pre-distortion error threshold, the pre-distortion data may be re-adjusted for each of the plurality of viewing positions and each of the plurality of viewing directions. Also, if the pre-distortion estimation is less than or equal to a pre-distortion error threshold, the pre-distortion data may not be re-adjusted for each of the plurality of viewing positions and each of the plurality of viewing directions.

At 924, GPU component 902 may generate lens calibration data for all of the plurality of viewing positions and all of the plurality of viewing directions based on the pre-distortion estimation for each of the plurality of viewing positions and each of the plurality of viewing directions. The lens calibration data may correspond to a lens distortion mesh. The lens distortion mesh may be associated with a plurality of non-linear transformations or delta corrections of the pre-distortion data for each of the plurality of viewing positions and each of the plurality of viewing directions. In some aspects, the lens calibration data may further include pupil rotation data associated with eye tracking data.

At 926, GPU component 902 may transmit the lens calibration data, e.g., data 930, for all of the plurality of viewing positions and all of the plurality of viewing directions.

At 950, GPU component 904 may receive lens calibration data, e.g., data 930, for a plurality of viewing positions and a plurality of viewing directions. The lens calibration data may further include pupil rotation data associated with eye tracking data. Also, the pupil rotation data may be utilized with the eye tracking data to determine an identifier (ID) of each of the plurality of geometry meshes. Moreover, the lens calibration data may correspond to a lens distortion mesh. The lens distortion mesh may be associated with a plurality of non-linear transformations or delta corrections of pre-distortion data for each of the plurality of viewing positions and each of the plurality of viewing directions. The plurality of viewing positions may be based on a camera or an eye position of a user in a headset or a head-mounted display (HMD), where the plurality of viewing directions is based on a camera or an eye gaze direction of a user in the headset or the HMD.

In some aspects, the lens calibration data may be associated with a pre-distortion estimation for each of the plurality of viewing positions and each of the plurality of viewing directions. If the pre-distortion estimation is greater than a pre-distortion error threshold, pre-distortion data may be re-adjusted for each of the plurality of viewing positions and each of the plurality of viewing directions. Also, if the pre-distortion estimation is less than or equal to a pre-distortion error threshold, pre-distortion data may not be re-adjusted for each of the plurality of viewing positions and each of the plurality of viewing directions.

At 952, GPU component 904 may generate, based on the lens calibration data, a pixel map including a plurality of calibration points associated with the plurality of viewing positions and the plurality of viewing directions, each of the plurality of calibration points being associated with a weighting factor. The pixel map may correspond to a look-up table (LUT) including a plurality of entries, where each of the plurality of entries in the LUT corresponds to a pixel location. Also, each of the plurality of entries in the LUT may correspond to at least one of a potential gaze location of a user or a potential pupil rotation of a user.

In some instances, each of the plurality of calibration points may correspond to a location of each of the plurality of viewing directions. Further, each of the plurality of calibration points may be associated with each of one or more coordinates in the pixel map. Each of the plurality of calibration points may also correspond to at least one of a potential gaze location of a user or a potential pupil rotation of a user.

At 954, GPU component 904 may determine a plurality of geometry meshes based on the lens calibration data, each of the plurality of geometry meshes including a set of texture coordinates. Each of the plurality of geometry meshes may include an identifier (ID). Further, each of the plurality of calibration points may correspond to the ID of one of the plurality of geometry meshes.

At 956, GPU component 904 may determine a render mesh including a plurality of coordinates based on the plurality of geometry meshes and the pixel map, each of the plurality of coordinates in the render mesh being associated with the weighting factor for each of the plurality of calibration points.

At 958, GPU component 904 may render display content, e.g., content 970, based on the determined render mesh including the plurality of coordinates.

At 960, GPU component 904 may transmit the display content, e.g., content 970, after rendering the display content, e.g., transmit the display content to display 906.

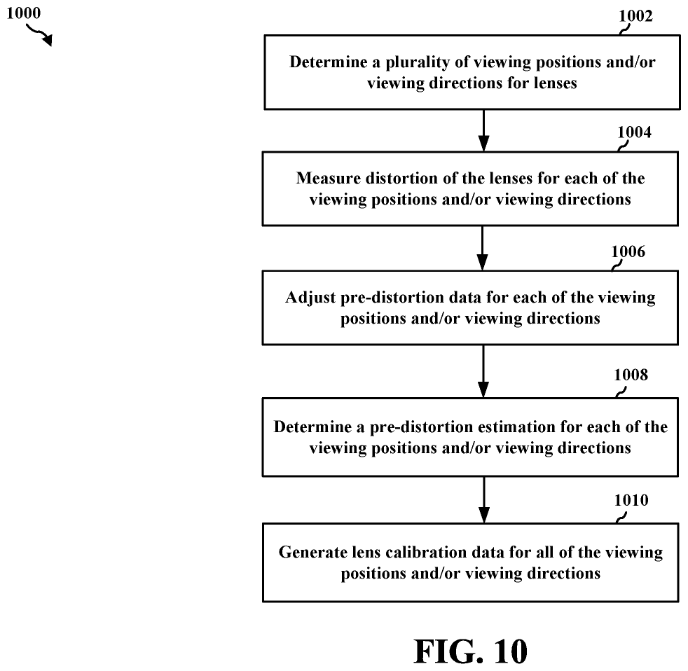

FIG. 10 is a flowchart 1000 of an example method of graphics processing in accordance with one or more techniques of this disclosure. The method may be performed by an apparatus, such as an apparatus for graphics processing, a GPU, another graphics processor, a GPU pipeline, a CPU, a data processor, a wireless communication device, and/or any apparatus that can perform data or graphics processing as used in connection with the examples of FIGS. 1-9.

At 1002, the apparatus may determine a plurality of viewing positions and a plurality of viewing directions for one or more lenses. For example, as described in 910 of FIG. 9, GPU component 902 may determine a plurality of viewing positions and a plurality of viewing directions for one or more lenses. Further, processing unit 120 in FIG. 1 may perform step 1002. The plurality of viewing positions may be determined based on a camera or an eye position of a user in a headset or a head-mounted display (HMD), where the plurality of viewing directions may be determined based on a camera or an eye gaze direction of a user in the headset or the HMD.

At 1004, the apparatus may measure an amount of distortion of the one or more lenses for each of the plurality of viewing positions and each of the plurality of viewing directions. For example, as described in 912 of FIG. 9, GPU component 902 may measure an amount of distortion of the one or more lenses for each of the plurality of viewing positions and each of the plurality of viewing directions. Further, processing unit 120 in FIG. 1 may perform step 1004. The amount of distortion of the one or more lenses may be based on light passing through the one or more lenses. Also, the amount of distortion of the one or more lenses may be associated with a spatially varying non-linear transformation.

At 1006, the apparatus may adjust, based on the measured distortion of the one or more lenses, pre-distortion data for each of the plurality of viewing positions and each of the plurality of viewing directions. For example, as described in 916 of FIG. 9, GPU component 902 may adjust, based on the measured distortion of the one or more lenses, pre-distortion data for each of the plurality of viewing positions and each of the plurality of viewing directions. Further, processing unit 120 in FIG. 1 may perform step 1006.

At 1008, the apparatus may determine, upon adjusting the pre-distortion data, a pre-distortion estimation for each of the plurality of viewing positions and each of the plurality of viewing directions. For example, as described in 922 of FIG. 9, GPU component 902 may determine, upon adjusting the pre-distortion data, a pre-distortion estimation for each of the plurality of viewing positions and each of the plurality of viewing directions. Further, processing unit 120 in FIG. 1 may perform step 1008. In some instances, if the pre-distortion estimation is greater than a pre-distortion error threshold, the pre-distortion data may be re-adjusted for each of the plurality of viewing positions and each of the plurality of viewing directions. Also, if the pre-distortion estimation is less than or equal to a pre-distortion error threshold, the pre-distortion data may not be re-adjusted for each of the plurality of viewing positions and each of the plurality of viewing directions.

At 1010, the apparatus may generate lens calibration data for all of the plurality of viewing positions and all of the plurality of viewing directions based on the pre-distortion estimation for each of the plurality of viewing positions and each of the plurality of viewing directions. For example, as described in 924 of FIG. 9, GPU component 902 may generate lens calibration data for all of the plurality of viewing positions and all of the plurality of viewing directions based on the pre-distortion estimation for each of the plurality of viewing positions and each of the plurality of viewing directions. Further, processing unit 120 in FIG. 1 may perform step 1010. The lens calibration data may correspond to a lens distortion mesh. The lens distortion mesh may be associated with a plurality of non-linear transformations or delta corrections of the pre-distortion data for each of the plurality of viewing positions and each of the plurality of viewing directions. In some aspects, the lens calibration data may further include pupil rotation data associated with eye tracking data.

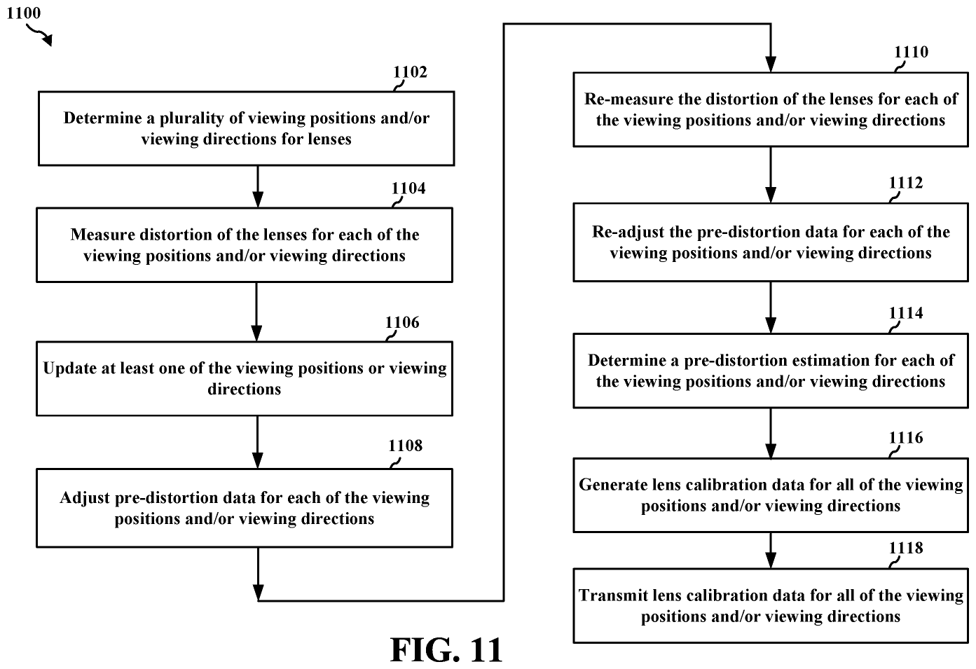

FIG. 11 is a flowchart 1100 of an example method of graphics processing in accordance with one or more techniques of this disclosure. The method may be performed by an apparatus, such as an apparatus for graphics processing, a GPU, another graphics processor, a GPU pipeline, a CPU, a data processor, a wireless communication device, and/or any apparatus that can perform data or graphics processing as used in connection with the examples of FIGS. 1-9.

At 1102, the apparatus may determine a plurality of viewing positions and a plurality of viewing directions for one or more lenses. For example, as described in 910 of FIG. 9, GPU component 902 may determine a plurality of viewing positions and a plurality of viewing directions for one or more lenses. Further, processing unit 120 in FIG. 1 may perform step 1102. The plurality of viewing positions may be determined based on a camera or an eye position of a user in a headset or a head-mounted display (HMD), where the plurality of viewing directions may be determined based on a camera or an eye gaze direction of a user in the headset or the HMD.

At 1104, the apparatus may measure an amount of distortion of the one or more lenses for each of the plurality of viewing positions and each of the plurality of viewing directions. For example, as described in 912 of FIG. 9, GPU component 902 may measure an amount of distortion of the one or more lenses for each of the plurality of viewing positions and each of the plurality of viewing directions. Further, processing unit 120 in FIG. 1 may perform step 1104. The amount of distortion of the one or more lenses may be based on light passing through the one or more lenses. Also, the amount of distortion of the one or more lenses may be associated with a spatially varying non-linear transformation.

At 1106, the apparatus may update at least one of the plurality of viewing positions or at least one of the plurality of viewing directions for the one or more lenses. For example, as described in 914 of FIG. 9, GPU component 902 may update at least one of the plurality of viewing positions or at least one of the plurality of viewing directions for the one or more lenses. Further, processing unit 120 in FIG. 1 may perform step 1106.

At 1108, the apparatus may adjust, based on the measured distortion of the one or more lenses, pre-distortion data for each of the plurality of viewing positions and each of the plurality of viewing directions. For example, as described in 916 of FIG. 9, GPU component 902 may adjust, based on the measured distortion of the one or more lenses, pre-distortion data for each of the plurality of viewing positions and each of the plurality of viewing directions. Further, processing unit 120 in FIG. 1 may perform step 1108.

At 1110, the apparatus may re-measure, upon adjusting the pre-distortion data, the amount of distortion of the one or more lenses for each of the plurality of viewing positions and each of the plurality of viewing directions. For example, as described in 918 of FIG. 9, GPU component 902 may re-measure, upon adjusting the pre-distortion data, the amount of distortion of the one or more lenses for each of the plurality of viewing positions and each of the plurality of viewing directions. Further, processing unit 120 in FIG. 1 may perform step 1110.

At 1112, the apparatus may re-adjust, based on the re-measured distortion of the one or more lenses, the pre-distortion data for each of the plurality of viewing positions and each of the plurality of viewing directions. For example, as described in 920 of FIG. 9, GPU component 902 may re-adjust, based on the re-measured distortion of the one or more lenses, the pre-distortion data for each of the plurality of viewing positions and each of the plurality of viewing directions. Further, processing unit 120 in FIG. 1 may perform step 1112. In some aspects, re-adjusting the pre-distortion data for each of the plurality of viewing positions and each of the plurality of viewing directions may further include combining a plurality of non-linear transformations or delta corrections for each of the plurality of viewing positions and each of the plurality of viewing directions.

At 1114, the apparatus may determine, upon adjusting the pre-distortion data, a pre-distortion estimation for each of the plurality of viewing positions and each of the plurality of viewing directions. For example, as described in 922 of FIG. 9, GPU component 902 may determine, upon adjusting the pre-distortion data, a pre-distortion estimation for each of the plurality of viewing positions and each of the plurality of viewing directions. Further, processing unit 120 in FIG. 1 may perform step 1114. In some instances, if the pre-distortion estimation is greater than a pre-distortion error threshold, the pre-distortion data may be re-adjusted for each of the plurality of viewing positions and each of the plurality of viewing directions. Also, if the pre-distortion estimation is less than or equal to a pre-distortion error threshold, the pre-distortion data may not be re-adjusted for each of the plurality of viewing positions and each of the plurality of viewing directions.

At 1116, the apparatus may generate lens calibration data for all of the plurality of viewing positions and all of the plurality of viewing directions based on the pre-distortion estimation for each of the plurality of viewing positions and each of the plurality of viewing directions. For example, as described in 924 of FIG. 9, GPU component 902 may generate lens calibration data for all of the plurality of viewing positions and all of the plurality of viewing directions based on the pre-distortion estimation for each of the plurality of viewing positions and each of the plurality of viewing directions. Further, processing unit 120 in FIG. 1 may perform step 1116. The lens calibration data may correspond to a lens distortion mesh. The lens distortion mesh may be associated with a plurality of non-linear transformations or delta corrections of the pre-distortion data for each of the plurality of viewing positions and each of the plurality of viewing directions. In some aspects, the lens calibration data may further include pupil rotation data associated with eye tracking data.

At 1118, the apparatus may transmit the lens calibration data for all of the plurality of viewing positions and all of the plurality of viewing directions. For example, as described in 926 of FIG. 9, GPU component 902 may transmit the lens calibration data for all of the plurality of viewing positions and all of the plurality of viewing directions. Further, processing unit 120 in FIG. 1 may perform step 1118.

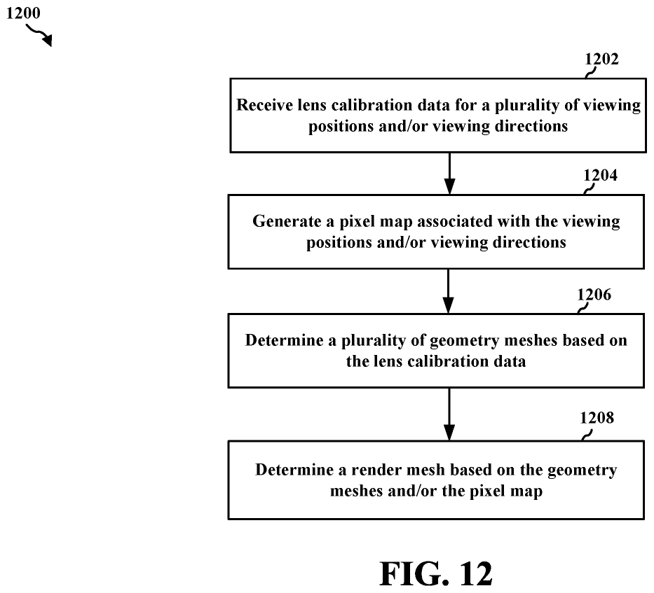

FIG. 12 is a flowchart 1200 of an example method of graphics processing in accordance with one or more techniques of this disclosure. The method may be performed by an apparatus, such as an apparatus for graphics processing, a GPU, another graphics processor, a GPU pipeline, a CPU, a data processor, a wireless communication device, and/or any apparatus that can perform data or graphics processing as used in connection with the examples of FIGS. 1-9.

At 1202, the apparatus may receive lens calibration data for a plurality of viewing positions and a plurality of viewing directions. For example, as described in 950 of FIG. 9, GPU component 904 may receive lens calibration data for a plurality of viewing positions and a plurality of viewing directions. Further, processing unit 120 in FIG. 1 may perform step 1202. The lens calibration data may further include pupil rotation data associated with eye tracking data. Also, the pupil rotation data may be utilized with the eye tracking data to determine an identifier (ID) of each of the plurality of geometry meshes. Moreover, the lens calibration data may correspond to a lens distortion mesh. The lens distortion mesh may be associated with a plurality of non-linear transformations or delta corrections of pre-distortion data for each of the plurality of viewing positions and each of the plurality of viewing directions. The plurality of viewing positions may be based on a camera or an eye position of a user in a headset or a head-mounted display (HMD), where the plurality of viewing directions is based on a camera or an eye gaze direction of a user in the headset or the HMD.

In some aspects, the lens calibration data may be associated with a pre-distortion estimation for each of the plurality of viewing positions and each of the plurality of viewing directions. If the pre-distortion estimation is greater than a pre-distortion error threshold, pre-distortion data may be re-adjusted for each of the plurality of viewing positions and each of the plurality of viewing directions. Also, if the pre-distortion estimation is less than or equal to a pre-distortion error threshold, pre-distortion data may not be re-adjusted for each of the plurality of viewing positions and each of the plurality of viewing directions.

At 1204, the apparatus may generate, based on the lens calibration data, a pixel map including a plurality of calibration points associated with the plurality of viewing positions and the plurality of viewing directions, each of the plurality of calibration points being associated with a weighting factor. For example, as described in 952 of FIG. 9, GPU component 904 may generate, based on the lens calibration data, a pixel map including a plurality of calibration points associated with the plurality of viewing positions and the plurality of viewing directions, each of the plurality of calibration points being associated with a weighting factor. Further, processing unit 120 in FIG. 1 may perform step 1204. The pixel map may correspond to a look-up table (LUT) including a plurality of entries, where each of the plurality of entries in the LUT corresponds to a pixel location. Also, each of the plurality of entries in the LUT may correspond to at least one of a potential gaze location of a user or a potential pupil rotation of a user.

In some instances, each of the plurality of calibration points may correspond to a location of each of the plurality of viewing directions. Further, each of the plurality of calibration points may be associated with each of one or more coordinates in the pixel map. Each of the plurality of calibration points may also correspond to at least one of a potential gaze location of a user or a potential pupil rotation of a user.

At 1206, the apparatus may determine a plurality of geometry meshes based on the lens calibration data, each of the plurality of geometry meshes including a set of texture coordinates. For example, as described in 954 of FIG. 9, GPU component 904 may determine a plurality of geometry meshes based on the lens calibration data, each of the plurality of geometry meshes including a set of texture coordinates. Further, processing unit 120 in FIG. 1 may perform step 1206. Each of the plurality of geometry meshes may include an identifier (ID). Further, each of the plurality of calibration points may correspond to the ID of one of the plurality of geometry meshes.

At 1208, the apparatus may determine a render mesh including a plurality of coordinates based on the plurality of geometry meshes and the pixel map, each of the plurality of coordinates in the render mesh being associated with the weighting factor for each of the plurality of calibration points. For example, as described in 956 of FIG. 9, GPU component 904 may determine a render mesh including a plurality of coordinates based on the plurality of geometry meshes and the pixel map, each of the plurality of coordinates in the render mesh being associated with the weighting factor for each of the plurality of calibration points. Further, processing unit 120 in FIG. 1 may perform step 1208.

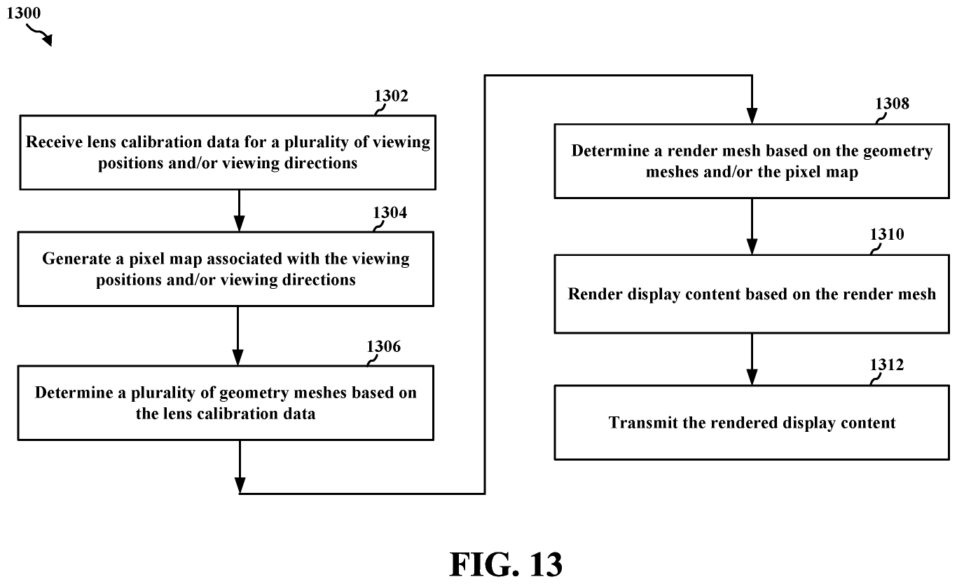

FIG. 13 is a flowchart 1300 of an example method of graphics processing in accordance with one or more techniques of this disclosure. The method may be performed by an apparatus, such as an apparatus for graphics processing, a GPU, another graphics processor, a GPU pipeline, a CPU, a data processor, a wireless communication device, and/or any apparatus that can perform data or graphics processing as used in connection with the examples of FIGS. 1-9.

At 1302, the apparatus may receive lens calibration data for a plurality of viewing positions and a plurality of viewing directions. For example, as described in 950 of FIG. 9, GPU component 904 may receive lens calibration data for a plurality of viewing positions and a plurality of viewing directions. Further, processing unit 120 in FIG. 1 may perform step 1302. The lens calibration data may further include pupil rotation data associated with eye tracking data. Also, the pupil rotation data may be utilized with the eye tracking data to determine an identifier (ID) of each of the plurality of geometry meshes. Moreover, the lens calibration data may correspond to a lens distortion mesh. The lens distortion mesh may be associated with a plurality of non-linear transformations or delta corrections of pre-distortion data for each of the plurality of viewing positions and each of the plurality of viewing directions. The plurality of viewing positions may be based on a camera or an eye position of a user in a headset or a head-mounted display (HMD), where the plurality of viewing directions is based on a camera or an eye gaze direction of a user in the headset or the HMD.

In some aspects, the lens calibration data may be associated with a pre-distortion estimation for each of the plurality of viewing positions and each of the plurality of viewing directions. If the pre-distortion estimation is greater than a pre-distortion error threshold, pre-distortion data may be re-adjusted for each of the plurality of viewing positions and each of the plurality of viewing directions. Also, if the pre-distortion estimation is less than or equal to a pre-distortion error threshold, pre-distortion data may not be re-adjusted for each of the plurality of viewing positions and each of the plurality of viewing directions.

At 1304, the apparatus may generate, based on the lens calibration data, a pixel map including a plurality of calibration points associated with the plurality of viewing positions and the plurality of viewing directions, each of the plurality of calibration points being associated with a weighting factor. For example, as described in 952 of FIG. 9, GPU component 904 may generate, based on the lens calibration data, a pixel map including a plurality of calibration points associated with the plurality of viewing positions and the plurality of viewing directions, each of the plurality of calibration points being associated with a weighting factor. Further, processing unit 120 in FIG. 1 may perform step 1304. The pixel map may correspond to a look-up table (LUT) including a plurality of entries, where each of the plurality of entries in the LUT corresponds to a pixel location. Also, each of the plurality of entries in the LUT may correspond to at least one of a potential gaze location of a user or a potential pupil rotation of a user.

In some instances, each of the plurality of calibration points may correspond to a location of each of the plurality of viewing directions. Further, each of the plurality of calibration points may be associated with each of one or more coordinates in the pixel map. Each of the plurality of calibration points may also correspond to at least one of a potential gaze location of a user or a potential pupil rotation of a user.

At 1306, the apparatus may determine a plurality of geometry meshes based on the lens calibration data, each of the plurality of geometry meshes including a set of texture coordinates. For example, as described in 954 of FIG. 9, GPU component 904 may determine a plurality of geometry meshes based on the lens calibration data, each of the plurality of geometry meshes including a set of texture coordinates. Further, processing unit 120 in FIG. 1 may perform step 1306. Each of the plurality of geometry meshes may include an identifier (ID). Further, each of the plurality of calibration points may correspond to the ID of one of the plurality of geometry meshes.

At 1308, the apparatus may determine a render mesh including a plurality of coordinates based on the plurality of geometry meshes and the pixel map, each of the plurality of coordinates in the render mesh being associated with the weighting factor for each of the plurality of calibration points. For example, as described in 956 of FIG. 9, GPU component 904 may determine a render mesh including a plurality of coordinates based on the plurality of geometry meshes and the pixel map, each of the plurality of coordinates in the render mesh being associated with the weighting factor for each of the plurality of calibration points. Further, processing unit 120 in FIG. 1 may perform step 1308.

At 1310, the apparatus may render display content based on the determined render mesh including the plurality of coordinates. For example, as described in 958 of FIG. 9, GPU component 904 may render display content based on the determined render mesh including the plurality of coordinates. Further, processing unit 120 in FIG. 1 may perform step 1310.

At 1312, the apparatus may transmit the display content after rendering the display content. For example, as described in 960 of FIG. 9, GPU component 904 may transmit the display content after rendering the display content. Further, processing unit 120 in FIG. 1 may perform step 1312.

In configurations, a method or an apparatus for graphics processing is provided. The apparatus may be a GPU, a graphics processor, a CPU, a data processor, or some other processor that may perform data or graphics processing. In aspects, the apparatus may be the processing unit 120 within the device 104, or may be some other hardware within the device 104 or another device. The apparatus, e.g., processing unit 120, may include means for determining a plurality of viewing positions and a plurality of viewing directions for one or more lenses; means for measuring an amount of distortion of the one or more lenses for each of the plurality of viewing positions and each of the plurality of viewing directions; means for adjusting, based on the measured distortion of the one or more lenses, pre-distortion data for each of the plurality of viewing positions and each of the plurality of viewing directions; means for determining, upon adjusting the pre-distortion data, a pre-distortion estimation for each of the plurality of viewing positions and each of the plurality of viewing directions; means for generating lens calibration data for all of the plurality of viewing positions and all of the plurality of viewing directions based on the pre-distortion estimation for each of the plurality of viewing positions and each of the plurality of viewing directions; means for re-measuring, upon adjusting the pre-distortion data, the amount of distortion of the one or more lenses for each of the plurality of viewing positions and each of the plurality of viewing directions; means for re-adjusting, based on the re-measured distortion of the one or more lenses, the pre-distortion data for each of the plurality of viewing positions and each of the plurality of viewing directions; means for updating at least one of the plurality of viewing positions or at least one of the plurality of viewing directions for the one or more lenses; means for transmitting the lens calibration data for all of the plurality of viewing positions and all of the plurality of viewing directions; means for receiving lens calibration data for a plurality of viewing positions and a plurality of viewing directions; means for generating, based on the lens calibration data, a pixel map including a plurality of calibration points associated with the plurality of viewing positions and the plurality of viewing directions, each of the plurality of calibration points being associated with a weighting factor; means for determining a plurality of geometry meshes based on the lens calibration data, each of the plurality of geometry meshes including a set of texture coordinates; means for determining a render mesh including a plurality of coordinates based on the plurality of geometry meshes and the pixel map, each of the plurality of coordinates in the render mesh being associated with the weighting factor for each of the plurality of calibration points; means for rendering display content based on the determined render mesh including the plurality of coordinates; and means for transmitting the display content after rendering the display content.

The subject matter described herein can be implemented to realize one or more benefits or advantages. For instance, the described graphics processing techniques can be used by a GPU, a graphics processor, a CPU, a data processor, or some other processor that can perform data or graphics processing to implement the dynamic distortion correction techniques described herein. This can also be accomplished at a low cost compared to other data or graphics processing techniques. Moreover, the data or graphics processing techniques herein can improve or speed up data processing or execution. Further, the data or graphics processing techniques herein can improve resource or data utilization and/or resource efficiency. Additionally, aspects of the present disclosure can utilize dynamic distortion correction in order to improve rendering accuracy and/or display accuracy at a GPU or headset/HMD.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of data processing. The method includes determining a plurality of viewing positions and a plurality of viewing directions for one or more lenses; measuring an amount of distortion of the one or more lenses for each of the plurality of viewing positions and each of the plurality of viewing directions; adjusting, based on the measured distortion of the one or more lenses, pre-distortion data for each of the plurality of viewing positions and each of the plurality of viewing directions; determining, upon adjusting the pre-distortion data, a pre-distortion estimation for each of the plurality of viewing positions and each of the plurality of viewing directions; and generating lens calibration data for all of the plurality of viewing positions and all of the plurality of viewing directions based on the pre-distortion estimation for each of the plurality of viewing positions and each of the plurality of viewing directions.

Aspect 2 is the method of aspect 1, further including re-measuring, upon adjusting the pre-distortion data, the amount of distortion of the one or more lenses for each of the plurality of viewing positions and each of the plurality of viewing directions.

Aspect 3 is the method of any of aspects 1 and 2, further including re-adjusting, based on the re-measured distortion of the one or more lenses, the pre-distortion data for each of the plurality of viewing positions and each of the plurality of viewing directions.

Aspect 4 is the method of any of aspects 1 to 3, where re-adjusting the pre-distortion data for each of the plurality of viewing positions and each of the plurality of viewing directions further includes combining a plurality of non-linear transformations or delta corrections for each of the plurality of viewing positions and each of the plurality of viewing directions.

Aspect 5 is the method of any of aspects 1 to 4, where the lens calibration data corresponds to a lens distortion mesh.

Aspect 6 is the method of any of aspects 1 to 5, where the lens distortion mesh is associated with a plurality of non-linear transformations or delta corrections of the pre-distortion data for each of the plurality of viewing positions and each of the plurality of viewing directions.

Aspect 7 is the method of any of aspects 1 to 6, where, if the pre-distortion estimation is greater than a pre-distortion error threshold, the pre-distortion data is re-adjusted for each of the plurality of viewing positions and each of the plurality of viewing directions.

Aspect 8 is the method of any of aspects 1 to 7, where, if the pre-distortion estimation is less than or equal to a pre-distortion error threshold, the pre-distortion data is not re-adjusted for each of the plurality of viewing positions and each of the plurality of viewing directions.

Aspect 9 is the method of any of aspects 1 to 8, where the lens calibration data further includes pupil rotation data associated with eye tracking data.

Aspect 10 is the method of any of aspects 1 to 9, where the amount of distortion of the one or more lenses is based on light passing through the one or more lenses.

Aspect 11 is the method of any of aspects 1 to 10, where the amount of distortion of the one or more lenses is associated with a spatially varying non-linear transformation.

Aspect 12 is the method of any of aspects 1 to 11, further including updating at least one of the plurality of viewing positions or at least one of the plurality of viewing directions for the one or more lenses.

Aspect 13 is the method of any of aspects 1 to 12, further including transmitting the lens calibration data for all of the plurality of viewing positions and all of the plurality of viewing directions.

Aspect 14 is the method of any of aspects 1 to 13, where the plurality of viewing positions is determined based on a camera or an eye position of a user in a headset or a head-mounted display (HMD), where the plurality of viewing directions is determined based on a camera or an eye gaze direction of a user in the headset or the HMD.

Aspect 15 is an apparatus for data processing including at least one processor coupled to a memory and configured to implement a method as in any of aspects 1 to 14.

Aspect 16 is the apparatus of aspect 15, further including a transceiver coupled to the at least one processor.

Aspect 17 is an apparatus for data processing including means for implementing a method as in any of aspects 1 to 14.

Aspect 18 is a computer-readable medium storing computer executable code, the code when executed by at least one processor causes the at least one processor to implement a method as in any of aspects 1 to 14.

Aspect 19 is a method of graphics processing. The method includes receiving lens calibration data for a plurality of viewing positions and a plurality of viewing directions; generating, based on the lens calibration data, a pixel map including a plurality of calibration points associated with the plurality of viewing positions and the plurality of viewing directions, each of the plurality of calibration points being associated with a weighting factor; determining a plurality of geometry meshes based on the lens calibration data, each of the plurality of geometry meshes including a set of texture coordinates; and determining a render mesh including a plurality of coordinates based on the plurality of geometry meshes and the pixel map, each of the plurality of coordinates in the render mesh being associated with the weighting factor for each of the plurality of calibration points.

Aspect 20 is the method of aspect 19, where the pixel map corresponds to a look-up table (LUT) including a plurality of entries, where each of the plurality of entries in the LUT corresponds to a pixel location.

Aspect 21 is the method of any of aspects 19 and 20, where each of the plurality of entries in the LUT corresponds to at least one of a potential gaze location of a user or a potential pupil rotation of a user.

Aspect 22 is the method of any of aspects 19 to 21, where each of the plurality of geometry meshes includes an identifier (ID).

Aspect 23 is the method of any of aspects 19 to 22, where each of the plurality of calibration points corresponds to the ID of one of the plurality of geometry meshes.

Aspect 24 is the method of any of aspects 19 to 23, where the lens calibration data further includes pupil rotation data associated with eye tracking data.

Aspect 25 is the method of any of aspects 19 to 24, where the pupil rotation data is utilized with the eye tracking data to determine an identifier (ID) of each of the plurality of geometry meshes.

Aspect 26 is the method of any of aspects 19 to 25, where each of the plurality of calibration points corresponds to a location of each of the plurality of viewing directions.

Aspect 27 is the method of any of aspects 19 to 26, where each of the plurality of calibration points are associated with each of one or more coordinates in the pixel map.

Aspect 28 is the method of any of aspects 19 to 27, where each of the plurality of calibration points corresponds to at least one of a potential gaze location of a user or a potential pupil rotation of a user.

Aspect 29 is the method of any of aspects 19 to 28, where the lens calibration data is associated with a pre-distortion estimation for each of the plurality of viewing positions and each of the plurality of viewing directions.

Aspect 30 is the method of any of aspects 19 to 29, where, if the pre-distortion estimation is greater than a pre-distortion error threshold, pre-distortion data is re-adjusted for each of the plurality of viewing positions and each of the plurality of viewing directions.

Aspect 31 is the method of any of aspects 19 to 30, where, if the pre-distortion estimation is less than or equal to a pre-distortion error threshold, pre-distortion data is not re-adjusted for each of the plurality of viewing positions and each of the plurality of viewing directions.

Aspect 32 is the method of any of aspects 19 to 31, where the lens calibration data corresponds to a lens distortion mesh.

Aspect 33 is the method of any of aspects 19 to 32, where the lens distortion mesh is associated with a plurality of non-linear transformations or delta corrections of pre-distortion data for each of the plurality of viewing positions and each of the plurality of viewing directions.

Aspect 34 is the method of any of aspects 19 to 33, further including rendering display content based on the determined render mesh including the plurality of coordinates.

Aspect 35 is the method of any of aspects 19 to 34, further including transmitting the display content after rendering the display content.

Aspect 36 is the method of any of aspects 19 to 35, where the plurality of viewing positions is based on a camera or an eye position of a user in a headset or a head-mounted display (HMD), where the plurality of viewing directions is based on a camera or an eye gaze direction of a user in the headset or the HMD.

Aspect 37 is an apparatus for graphics processing including at least one processor coupled to a memory and configured to implement a method as in any of aspects 19 to 36.

Aspect 38 is the apparatus of aspect 37, further including a transceiver coupled to the at least one processor.

Aspect 39 is an apparatus for graphics processing including means for implementing a method as in any of aspects 19 to 36.

Aspect 40 is a computer-readable medium storing computer executable code, the code when executed by at least one processor causes the at least one processor to implement a method as in any of aspects 19 to 36.

What is claimed is:

1. An apparatus for data processing, comprising:
a memory; and
at least one processor coupled to the memory and configured to:
determine a plurality of viewing positions and a plurality of viewing directions for one or more lenses;
measure an amount of distortion of the one or more lenses for each of the plurality of viewing positions and each of the plurality of viewing directions;
adjust, based on the measured distortion of the one or more lenses, pre-distortion data for each of the plurality of viewing positions and each of the plurality of viewing directions;
determine, upon adjusting the pre-distortion data, a pre-distortion estimation for each of the plurality of viewing positions and each of the plurality of viewing directions; and
generate lens calibration data for all of the plurality of viewing positions and all of the plurality of viewing directions based on the pre-distortion estimation for each of the plurality of viewing positions and each of the plurality of viewing directions.

2. The apparatus of claim 1, wherein the at least one processor is further configured to:
re-measure, upon adjusting the pre-distortion data, the amount of distortion of the one or more lenses for each of the plurality of viewing positions and each of the plurality of viewing directions.

3. The apparatus of claim 2, wherein the at least one processor is further configured to:
re-adjust, based on the re-measured distortion of the one or more lenses, the pre-distortion data for each of the plurality of viewing positions and each of the plurality of viewing directions.

4. The apparatus of claim 3, wherein re-adjusting the pre-distortion data for each of the plurality of viewing positions and each of the plurality of viewing directions further comprises the at least one processor configured to combine a plurality of non-linear transformations or delta corrections for each of the plurality of viewing positions and each of the plurality of viewing directions.

5. The apparatus of claim 1, wherein the lens calibration data corresponds to a lens distortion mesh.

6. The apparatus of claim 5, wherein the lens distortion mesh is associated with a plurality of non-linear transformations or delta corrections of the pre-distortion data for each of the plurality of viewing positions and each of the plurality of viewing directions.

7. The apparatus of claim 1, wherein, if the pre-distortion estimation is greater than a pre-distortion error threshold, the pre-distortion data is re-adjusted for each of the plurality of viewing positions and each of the plurality of viewing directions.

8. The apparatus of claim 1, wherein, if the pre-distortion estimation is less than or equal to a pre-distortion error threshold, the pre-distortion data is not re-adjusted for each of the plurality of viewing positions and each of the plurality of viewing directions.

9. The apparatus of claim 1, wherein the lens calibration data further includes pupil rotation data associated with eye tracking data.

10. The apparatus of claim 1, wherein the amount of distortion of the one or more lenses is based on light passing through the one or more lenses.

11. The apparatus of claim 1, wherein the amount of distortion of the one or more lenses is associated with a spatially varying non-linear transformation.

12. The apparatus of claim 1, wherein the at least one processor is further configured to:
update at least one of the plurality of viewing positions or at least one of the plurality of viewing directions for the one or more lenses.

13. The apparatus of claim 1, wherein the at least one processor is further configured to:
transmit the lens calibration data for all of the plurality of viewing positions and all of the plurality of viewing directions.

14. The apparatus of claim 1, wherein the plurality of viewing positions is determined based on a camera or an eye position of a user in a headset or a head-mounted display (HMD), wherein the plurality of viewing directions is determined based on a camera or an eye gaze direction of a user in the headset or the HMD.

15. The apparatus of claim 1, further comprising a transceiver coupled to the at least one processor.

16. A method of data processing, comprising:
determining a plurality of viewing positions and a plurality of viewing directions for one or more lenses;
measuring an amount of distortion of the one or more lenses for each of the plurality of viewing positions and each of the plurality of viewing directions;
adjusting, based on the measured distortion of the one or more lenses, pre-distortion data for each of the plurality of viewing positions and each of the plurality of viewing directions;
determining, upon adjusting the pre-distortion data, a pre-distortion estimation for each of the plurality of viewing positions and each of the plurality of viewing directions; and
generating lens calibration data for all of the plurality of viewing positions and all of the plurality of viewing directions based on the pre-distortion estimation for each of the plurality of viewing positions and each of the plurality of viewing directions.

17. An apparatus for graphics processing, comprising:
a memory; and
at least one processor coupled to the memory and configured to:
receive lens calibration data for a plurality of viewing positions and a plurality of viewing directions;
generate, based on the lens calibration data, a pixel map including a plurality of calibration points associated with the plurality of viewing positions and the plurality of viewing directions, each of the plurality of calibration points being associated with a weighting factor;
determine a plurality of geometry meshes based on the lens calibration data, each of the plurality of geometry meshes including a set of texture coordinates; and
determine a render mesh including a plurality of coordinates based on the plurality of geometry meshes and the pixel map, each of the plurality of coordinates in the render mesh being associated with the weighting factor for each of the plurality of calibration points.

18. The apparatus of claim 17, wherein the pixel map corresponds to a look-up table (LUT) including a plurality of entries, wherein each of the plurality of entries in the LUT corresponds to a pixel location.

19. The apparatus of claim 18, wherein each of the plurality of entries in the LUT corresponds to at least one of a potential gaze location of a user or a potential pupil rotation of a user.

20. The apparatus of claim 17, wherein each of the plurality of geometry meshes includes an identifier (ID).

21. The apparatus of claim 20, wherein each of the plurality of calibration points corresponds to the ID of one of the plurality of geometry meshes.

22. The apparatus of claim 17, wherein the lens calibration data further includes pupil rotation data associated with eye tracking data.

23. The apparatus of claim 22, wherein the pupil rotation data is utilized with the eye tracking data to determine an identifier (ID) of each of the plurality of geometry meshes.

24. The apparatus of claim 17, wherein each of the plurality of calibration points corresponds to a location of each of the plurality of viewing directions.

25. The apparatus of claim 17, wherein each of the plurality of calibration points are associated with each of one or more coordinates in the pixel map.

26. The apparatus of claim 17, wherein each of the plurality of calibration points corresponds to at least one of a potential gaze location of a user or a potential pupil rotation of a user.

27. The apparatus of claim 17, wherein the lens calibration data is associated with a pre-distortion estimation for each of the plurality of viewing positions and each of the plurality of viewing directions.

28. The apparatus of claim 27, wherein, if the pre-distortion estimation is greater than a pre-distortion error threshold, pre-distortion data is re-adjusted for each of the plurality of viewing positions and each of the plurality of viewing directions.

29. The apparatus of claim 27, wherein, if the pre-distortion estimation is less than or equal to a pre-distortion error threshold, pre-distortion data is not re-adjusted for each of the plurality of viewing positions and each of the plurality of viewing directions.

30. The apparatus of claim 17, wherein the lens calibration data corresponds to a lens distortion mesh.

31. The apparatus of claim 30, wherein the lens distortion mesh is associated with a plurality of non-linear transformations or delta corrections of pre-distortion data for each of the plurality of viewing positions and each of the plurality of viewing directions.

32. The apparatus of claim 17, wherein the at least one processor is further configured to:
render display content based on the determined render mesh including the plurality of coordinates.

33. The apparatus of claim 32, wherein the at least one processor is further configured to:
transmit the display content after rendering the display content.

34. The apparatus of claim 17, wherein the plurality of viewing positions is based on a camera or an eye position of a user in a headset or a head-mounted display (HMD), wherein the plurality of viewing directions is based on a camera or an eye gaze direction of a user in the headset or the HMD.

35. The apparatus of claim 17, further comprising a transceiver coupled to the at least one processor.

36. A method of graphics processing, comprising:
receiving lens calibration data for a plurality of viewing positions and a plurality of viewing directions;
generating, based on the lens calibration data, a pixel map including a plurality of calibration points associated with the plurality of viewing positions and the plurality of viewing directions, each of the plurality of calibration points being associated with a weighting factor;
determining a plurality of geometry meshes based on the lens calibration data, each of the plurality of geometry meshes including a set of texture coordinates; and
determining a render mesh including a plurality of coordinates based on the plurality of geometry meshes and the pixel map, each of the plurality of coordinates in the render mesh being associated with the weighting factor for each of the plurality of calibration points.
